(19) United States
(12) Patent Application Publication
(10) Pub. No.: US 2024/0171577 A1
(43) Pub. Date: May 23, 2024

(54) METHOD, APPARATUS, AND COMPUTER-READABLE RECORDING MEDIUM FOR CONTROLLING ACCESS TO REMOTE SYSTEM IN HOME NETWORK ENVIRONMENT

(71) Applicant: SGA Solutions Co.,Ltd., Seoul (KR)

(72) Inventors: Ki Uk LEE, Seongnam-si (KR); Se Yun KIM, Namyangju-si (KR); Jae Hyeok PARK, Seoul (KR)

(21) Appl. No.: 18/337,179

(22) Filed: Jun. 19, 2023

(30) Foreign Application Priority Data
Nov. 22, 2022 (KR) 10-2022-0157105

(51) Int. Cl. H04L 9/40

(52) U.S. Cl. CPC H04L 63/10

(57) ABSTRACT

Access of a home network terminal to a work server in a telecommuting environment is effectively managed to maintain security of the terminal. According to one embodiment of the present invention, a method for controlling access to a remote system in a home network environment includes: an access request reception step of receiving a request signal according to a network protocol when an access request for a remote server, which is an access target, is performed by a terminal on a home network; a security environment inspection step of checking the security environment of the terminal through a host sensor for each protocol that has received the request signal through the access request reception step; and an access permission step of managing access to the remote server according to the security environment checked according to a result of performing the security environment inspection step.

### BACKGROUND OF THE INVENTION

### 1. Field of the Invention

The present invention relates to a technology for controlling safe access to a terminal on a home network in an internal work system of a company in an environment in which the terminal accesses a remote server through a home network environment, such as telecommuting, and more particularly, to a technology for enabling smooth remote access while maintaining security of an internal work system of a company by inspecting a security environment of a terminal and inducing improvement of the security environment through the inspection.

### 2. Description of the Related Art

Recently, telecommuting is a form of work that is being applied to many companies as flexibility and efficiency of a work have been proven, a non-face-to-face meeting platform, an electronic payment system, and the like have been developed, and infectious diseases and the like have been spread. The telecommuting refers to a technology of allowing a worker to perform a work at home or in other network environments, and to upload a work execution result to a server of a company or perform the work on the server of the company.

Since such a technology includes a characteristic that a remote home network terminal has no alternative but to access an in-house work server of a company, which has to ensure security, through a network that does not ensure security, rather than using a terminal and an internal network that ensure security in the company, security of the technology may be greatly threatened.

In the past, such access to the work server of the company through a remote home network has been managed simply with an ID, a password, and the like only, so that only a basic security agent is installed in a remote terminal, and it is general for the remote terminal to perform the access in a state where a security network environment of the company is not ensured for the remote terminal, and thus the remote terminal is inevitably exposed to threats such as hacking. Accordingly, risks such as leakage of company secrets have always been pointed out, and actual damages such as technology leakage have occurred.

Accordingly, for example, Korean Patent Registration No. 10-1460106 and the like have disclosed a technology for forming IPsec security tunneling in a path on a network leading to a gateway (BYOD gateway) according to access policy information used when accessing a company service server, and allowing a terminal to perform access through the IPsec security tunneling.

However, such technologies only improve security on a network basis, so that the remote terminal is still exposed to a risk of hacking. When the remote terminal has a malicious program such as malware, or the terminal has been hacked, hacking may be possible by accessing the company server through a security network, so that it is necessary to prepare for such hacking.

### SUMMARY OF THE INVENTION

Accordingly, an object of the present invention is to provide a technology for effectively managing access of a home network terminal to a work server in a telecommuting environment to maintain security of the terminal, so that it is possible to prepare for all threats to work servers of companies, and in particular, it is possible to respond to and prepare for security threats to the terminal.

To achieve the object described above, according to one embodiment of the present invention, there is provided a method for controlling access to a remote system in a home network environment, which is implemented by a computing device including at least one processor and at least one memory for storing instructions executable by the processor, the method including: an access request reception step of receiving a request signal according to a network protocol when an access request for a remote server, which is an access target, is performed by a terminal on a home network; a security environment inspection step of checking a security environment of the terminal through a host sensor for each protocol that has received the request signal through the access request reception step; and an access permission step of managing access to the remote server according to the security environment checked according to a result of performing the security environment inspection step.

The security environment inspection step may include: a packet transmission step of transmitting a packet included in the request signal of the terminal to the host sensor; an inspection step of receiving inspection information, which is information on whether the terminal is a first terminal that is in a managed state or a second terminal that is in an unmanaged state, from the host sensor as a result derived by analyzing the packet by the host sensor; and a terminal processing step of performing processing for switching the terminal to the first terminal that is in the managed state when the terminal is the second terminal as a determination result of the inspection step.

The inspection information may be a result of decoding the packet and organizing packet information by the host sensor, determining whether a security agent to be installed in the terminal is installed according to a security policy set in the remote server based on the organized packet information, and determining a terminal in which all security agents are installed as the first terminal and a terminal in which the security agent is not installed as the second terminal.

The terminal processing step may include redirecting a packet of the second terminal to a security server for performing an installation process of the security agent according to the security policy set in the remote server, which is a server provided separately from the remote server, so as to control the terminal to access an installation page of the security agent.

The terminal processing step may include switching the second terminal to the first terminal when determined that the second terminal has accessed the security server to install all the security agents.

The access permission step may include permitting the access to the remote server only when the terminal is the first terminal.

Meanwhile, according to one embodiment of the present invention, there is provided an apparatus for controlling access to a remote system in a home network environment, which is implemented by a computing device including at least one processor and at least one memory for storing instructions executable by the processor, the apparatus including: an access request reception unit for receiving a request signal according to a network protocol when an access request for a remote server, which is an access target, is performed by a terminal on a home network; a security environment inspection unit for checking a security environment of the terminal by verifying the request signal received by the access request reception unit through a host sensor for each protocol; and an access permission unit for managing access to the remote server according to a security environment checking result of the security environment inspection unit.

According to the present invention, for a terminal that performs an access request to access an internal work server of a company, a host sensor may analyze a packet of a signal corresponding to the access request so as to control access to the work server depending on whether a security agent that has to be installed according to a company internal security policy is installed based on information of the packet.

In particular, a terminal in which the security agent that has to be installed according to the security policy is not installed may be set to an unmanaged state, the access may be redirected so as to access a security server for installing the security agent in the company and install the security agent, and the access to a remote work server may be permitted when the security agent is installed, so that security of the terminal can be maintained, and thus it is possible to prepare for all threats to work servers of companies, and in particular, it is possible to respond to and prepare for security threats to the terminal.

### BRIEF DESCRIPTION OF THE DRAWINGS

FIGS. 1 and 2 are flowcharts showing a method for controlling access to a remote system in a home network environment according to one embodiment of the present invention.

FIG. 3 is a block diagram showing an apparatus for controlling access to a remote system in a home network environment according to one embodiment of the present invention.

FIG. 4 is a view for describing a function of a host sensor according to one embodiment of the present invention.

FIG. 5 shows an example of a security server access screen output to a second terminal according to one embodiment of the present invention.

FIG. 6 is a schematic diagram showing a network environment according to one embodiment of the present invention.

FIG. 7 shows one example of an internal configuration of a computing device according to one embodiment of the present invention.

### DETAILED DESCRIPTION OF THE INVENTION

Hereinafter, various embodiments and/or aspects will be disclosed with reference to the drawings. In the following description, for the purpose of description, numerous specific details are set forth in order to facilitate an overall understanding of one or more aspects. However, it will also be appreciated by a person having ordinary skill in the art to which the present invention pertains that such aspect(s) may be practiced without the specific details. The following description and the accompanying drawings will be set forth in detail for specific illustrative aspects among the one or more aspects. However, the aspects are provided for illustrative purposes, some of various schemes based on principles of various aspects may be employed, and descriptions set forth herein are intended to include all the aspects and equivalents thereof.

The terms “embodiment”, “example”, “aspect”, “illustration”, and the like used herein may not be construed as indicating that any aspect or design set forth herein is preferable or advantageous over other aspects or designs.

In addition, it is to be understood that the terms “include” and/or “comprise” indicate the presence of corresponding features and/or elements, but do not preclude the presence or addition of one or more other features, elements, and/or groups thereof.

In addition, although the tams including ordinal numbers such as “first” and “second” may be used to describe various elements, the elements are not limited by the terms. The above terms are used merely for the purpose of distinguishing one element from another element. For example, a first element may be termed as a second element, and similarly, a second element may also be teamed as a first element without departing from the scope of the present invention. The term “and/or” includes any combination of a plurality of described relevant items, or one of the described relevant items.

In addition, unless defined otherwise, all terms used in embodiments of the present invention, including technical and scientific teams, have the same meaning as those commonly understood by a person having ordinary skill in the art to which the present invention pertains. Any terms as those defined in generally used dictionaries are to be interpreted to have the meanings consistent with the contextual meanings in the relevant field of art, and are not to be interpreted to have idealistic or excessively formalistic meanings unless explicitly defined in the embodiments of the present invention.

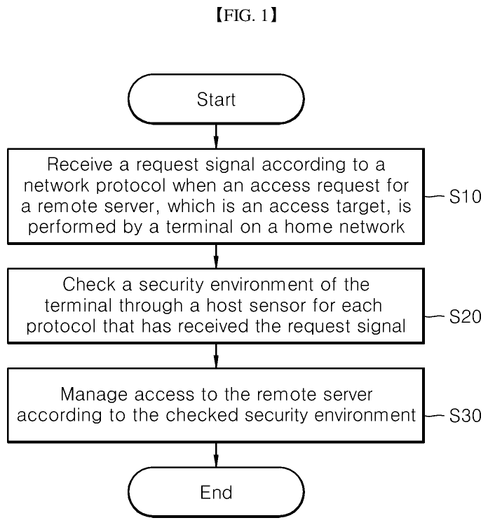

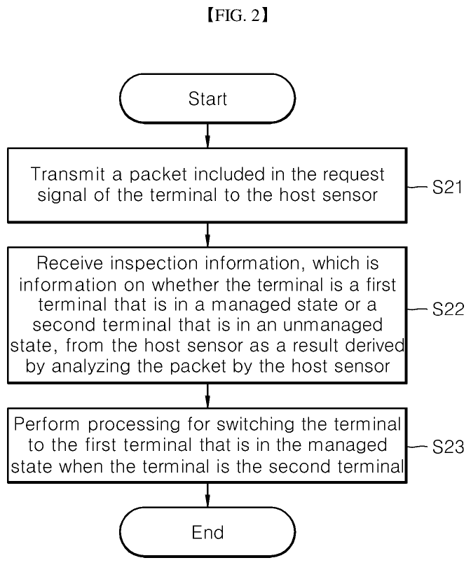

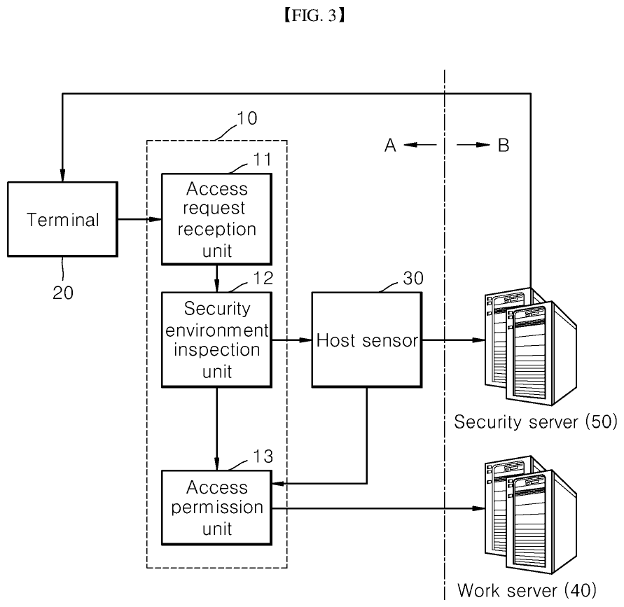

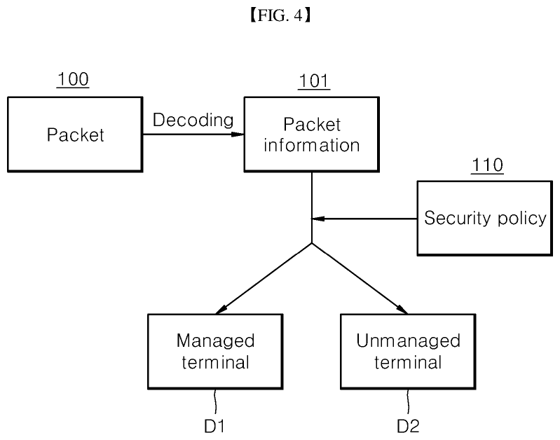

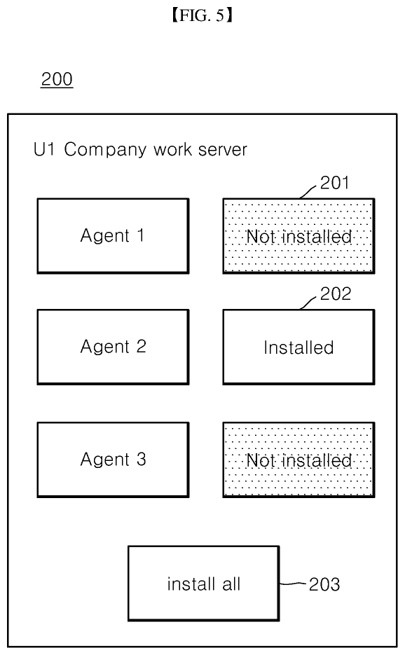

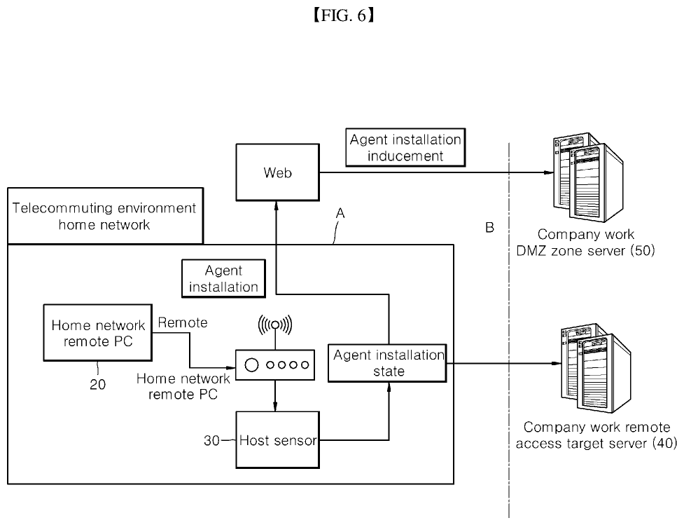

FIGS. 1 and 2 are flowcharts showing a method for controlling access to a remote system in a home network environment according to one embodiment of the present invention, FIG. 3 is a block diagram showing an apparatus for controlling access to a remote system in a home network environment according to one embodiment of the present invention, FIG. 4 is a view for describing a function of a host sensor according to one embodiment of the present invention, FIG. 5 shows an example of a security server access screen output to a second terminal according to one embodiment of the present invention, and FIG. 6 is a schematic diagram showing a network environment according to one embodiment of the present invention. In the following description, various embodiments and detailed configurations of the present invention will be described with reference to a plurality of drawings together.

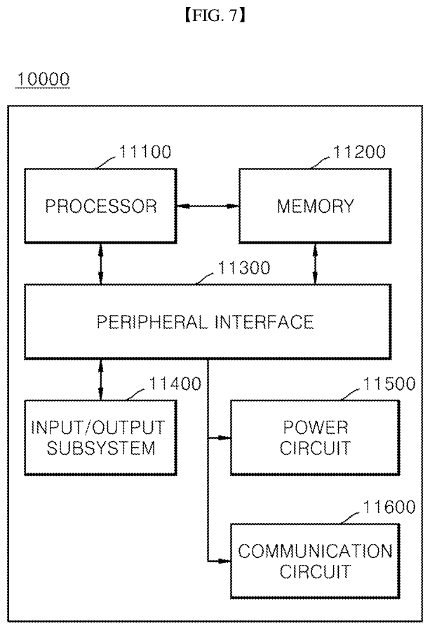

Referring to the drawings of the present invention together as described above, it will be understood that a method for controlling access to a remote system in a home network environment according to one embodiment of the present invention may be performed by detailed configurations of an apparatus 10 for controlling access to a remote system in a home network environment (hereinafter referred to as “apparatus according to the present invention”), which will be described with reference to FIG. 3, or a computing device of FIG. 7. In other words, it will be understood that the apparatus 10 according to the present invention may be implemented as the computing device of FIG. 7, a portion of the computing device, or groupware of a plurality of computing devices, and the detailed configurations of the apparatus 10 according to the present invention may be classified according to a function of each of components that will be described below in a processor or a memory.

According to the method for controlling the access to the remote system in the home network environment of one embodiment of the present invention, first, the computing device may perform an access request reception step S10 of receiving a request signal according to a network protocol when an access request for a remote server, which is an access target, is performed by a terminal on a home network.

According to the present invention, the terminal on the home network may include all terminals that are installed in the home network environment to attempt to access a work server, which is a work-related server in a company internal network environment. For example, the terminal on the home network may include a personal PC, a smart phone, a smart pad, and all other network-accessible terminals. Basically, the terminal may access a remote work server by accessing a communication network through a gateway of the home network, and the work server may be present inside a physical or software firewall structure in the company internal network environment.

The home network environment may refer to construction of a network among various information devices inside the home. In more detail, the home network environment may refer to construction an environment in which information home appliances communicate with each other through a wired/wireless network inside the home and are mutually accessible through the Internet outside the home.

Basically, the home network environment may refer to a technology for remotely controlling and integrating all digital electronic products connected through the network, such as an Internet home appliance, a digital VRC, a DVD player, and security equipment. Although this system, which started with home automation in the 1980s, has formed a home automation market based on communication, video, crime prevention, disaster prevention, and remote control functions, it was difficult to use the system, and the system was expensive, so that the system has not been widely distributed. Currently, due to development of an Internet environment and a computer technology, a stage where convenience and efficiency may be maximized by controlling all electronic devices in the home is being reached. A residential environment as an IT house is being changed to allow operations of automatically requesting an after-sales service through a server for failures or errors of home appliances, ordering foods through the Internet when there is no food in a refrigerator, and the like.

A technology constituting the home network environment may include various application technologies, and a wireless technology capable of transmitting various signals without the need to lay a new line is being applied as a core. Currently, a wireless technology constituting the home network may include a wireless LAN technology, a wireless PAN technology, an ultra-wideband (UWB) technology, a wireless 1394 technology, a ZigBee technology, a home RF technology, and the like.

A networking technology may be broadly divided into wired and wireless technologies, in which the wired technology may include phone line, power line, Ethernet, IEEE 1394, and USB technologies, and IEEE 802.11x-series wireless LAN, home RF, Bluetooth, ultra-wideband, ZigBee, and hyper LAN technologies are emerging and developing as the wireless technology.

According to the present invention, the home network environment will be understood to collectively refer to all environments other than the company internal network environment in which a security network is formed by a firewall and the like, that is, a network environment that is accessible by a terminal from an outside of a company, including a network environment in the concept of the home network described above.

The remote server, which is the access target of the terminal, may basically refer to a server terminal in the company internal network environment that has to be accessed to allow the terminal to perform a work, or transmit a work execution result of the terminal to an inside of the company in a telecommuting environment. All data, which is a security target in the company, may be managed in the remote server, and the remote server may be basically protected through a security network such as a security agent and other hardware.

Company network security may refer to a series of strategies, processes, and technologies designed to protect a network of a company from unauthorized access and damage to a company internal server. Common threats to network data and infrastructure may include hackers, malware, viruses, and the like, all of which attempt to access, intrude, and modify the network. A top priority in network security is to prevent such threats from intruding the network to propagate through the network by controlling access.

Multiple defense lines may protect the network at and within an edge. Security may start with access control. Access of unauthorized users, devices, and data to the network may be managed through policies and controls. A firewall (hardware or software) may be another primary defense line, and may monitor and control traffics transmitted to and received from the network so as to separate the network from other untrusted networks (e.g. the Internet). In addition, the network security may identify and respond to network threats by using intrusion detection and intrusion prevention systems that analyze network traffics. One of important subcomponent of the network security is application security. Since web applications and software used by the company usually have vulnerabilities, the application security may protect the applications. Various other strategies and technologies may be used to maintain security in data centers, public clouds, and the like.

When the access request for the remote server is performed by the terminal, the apparatus according to the present invention may receive a request signal from the terminal according to the network protocol, which is used by the terminal according to the home network environment.

When the step S10 is performed, the apparatus according to the present invention may perform a security environment inspection step S20 of checking a security environment of the terminal through a host sensor for each protocol that has received the request signal for the access request.

According to the present invention, the host sensor for each protocol may be a hardware or software sensor connected to a gateway of the home network environment, and may perform a function of checking the security environment of the terminal by catching and analyzing the request signal corresponding to the access request.

In detail, through the embodiment shown in FIG. 2, the host sensor may check the security environment of the terminal, and perform processing on the terminal according to the checked security environment.

The terminal may be divided into a managed state and an unmanaged state according to the checking of the security environment, in which the managed state may refer to a state of the terminal in which the security environment is appropriate, and the unmanaged state may refer to a state of the terminal in which the security environment is inappropriate. When the terminal is determined to be in the managed state as a result of performing the step S20, the apparatus according to the present invention may perform an access permission step S30 of managing access to the remote server according to the checked security environment so as to normally permit the access to the remote server. However, in a case of the unmanaged state, processing for switching a state of the terminal to the managed state may be performed in the step S20 as will be described below.

The process will be described in detail below. First, the computing device, that is, the apparatus according to the present invention, may perform a packet transmission step S21 of transmitting a packet included in the request signal of the terminal to the host sensor.

The host sensor may determine whether the terminal is in the managed state or the unmanaged state, which is described above, by analyzing the packet. For example, as shown in FIG. 4, a packet 100 included in the request signal transmitted from the terminal may be analyzed. In other words, after the step S21 is performed, the apparatus according to the present invention may perform an inspection step S22 of receiving inspection information, which is information on whether the terminal is a first terminal that is in a managed state or a second terminal that is in an unmanaged state, from the host sensor as a result derived by analyzing the packet by the host sensor.

Thereafter, the apparatus according to the present invention may perform a terminal processing step S23 of performing processing for switching the terminal to the first terminal that is in the managed state when the terminal is the second terminal as a determination result of the step S22.

In addition, the inspection information may include a result of analyzing the packet included in the request signal by the host sensor. In detail, as shown in FIG. 4, the inspection information may refer to information on the security environment that may be derived from information on the packet as a result of decoding the packet for each protocol and organizing detailed information 101 on the packet by the host sensor.

In this case, the information on the security environment may refer to determination information on whether values in a detailed column and a format of the packet are set in the packet by a function of a security agent as a result of decoding the packet included in the request signal. In addition, an installation state of the security agent in the terminal may be determined through a scheme of identifying tags coupled to the beginning and end of the packet to identify a communication protocol, or the like.

As a specific example, a field such as SgaTrustStatus: SgaAgent=True may be added to an end of a request header, which is an Http header in the request signal from the terminal in which the security agent is installed, and the field may be added to the header by adding a function by a firewall of a host installed in the server. Accordingly, when the field exists, it may be determined that the agent has been installed, and when the field does not exist, it may be determined that a required security agent has not been installed.

In other words, the inspection information may be a result of determining a terminal in which all security agents, which are installation targets, are installed as a first terminal D1 and a terminal in which the security agent is not installed as a second terminal D2 according to a security policy 110 associated with an internal firewall of the company in order to access the company internal network environment. That is, the inspection information may be information indicating the state of the terminal that has performed the access request.

While performing the step S23, the apparatus according to the present invention may form a network zone that is exceptionally accessible by the second terminal in the company internal network environment as a so-called ‘DMZ zone’, and may induce the terminal to access the zone through a web environment. Such a zone may be referred to as a security server in the company internal network environment so as to be distinguished from the remote server.

In the step S23, the apparatus according to the present invention may redirect a packet of the second terminal to a security server for performing an installation process of the security agent according to the security policy set in the remote server, which is a server provided separately from the remote server, so as to control the terminal to access an installation page of the security agent, in addition to preventing the terminal from accessing the remote server by transmitting the packet of the second terminal to the remote server or the server.

For example, when the second terminal attempts to access the remote server, a web screen 200 as shown in FIG. 5 may be output as a result of performing the function described above. The web screen 200 may be a result of accessing the security server, and may include information on an installed (202) or not-installed (201) state of each of the security agents Agents 1 to 3 together with a menu item 203 for installing each of the security agents so as to induce installation of the security agent.

Thereafter, when the installation of all the security agents in the terminal is completed in the web environment, the step S30 may be performed again so that the terminal may access the remote server so as to be switched to a state in which telecommuting is enabled.

In other words, the apparatus according to the present invention may determine whether all the security agents are installed as a result of redirecting to the security server and accessing the security server while performing the step S23 through re-execution of the steps S10 and S20 after termination of the access to the security server, and may switch the state of the terminal from the second terminal to the first terminal when the host sensor determines that all the security agents are installed, or log information on the installation of the security agent is recognized. In other words, in the step S30, the access to the remote server may be permitted only when the terminal is the first terminal.

According to execution of the function described above, rather than simply inducing the installation of the security agent, the security agent, which is an installation target, in the company internal network environment according to the security policy of the company may be induced to be installed on the terminal for the access to the remote server associated with a work of the company in a telecommuting environment, and in particular, the host sensor may determine whether the terminal is in the managed state through packet analysis on all terminals. Accordingly, when compared with the conventional technologies such as a technology for forming a list of clients and permitting only access to the clients included in the list, restrictions on available terminals in constructing a telecommuting environment by a worker may be greatly reduced, and strong security may be maintained even when a range of available terminals becomes very wide.

FIG. 3 shows a view showing a configuration of the apparatus 10 according to the present invention described above. While describing the apparatus 10 according to the present invention, redundant descriptions of components corresponding to all the descriptions set forth above will be omitted.

Referring to FIG. 3, the apparatus 10 according to the present invention may include an access request reception unit 11, a security environment inspection unit 12, and an access permission unit 13. The access request reception unit 11 may perform a function of receiving a request signal according to a network protocol when an access request for a remote server 40 on a company internal network B, which is an access target, is performed by a terminal 20 on a home network A. In other words, the access request reception unit 11 may be understood as a configuration that performs all the functions mentioned in the step S10 described above.

The security environment inspection unit 12 may perform a function of checking a security environment of the terminal 20 by verifying the request signal received by the access request reception unit 11 through a host sensor 30 for each protocol. In addition, when the terminal 20 is determined as being the second terminal as described above, the security environment inspection unit 12 may perform a function of redirecting a packet of the terminal 20 to a security server 50 to allow the terminal 20 to access the security server 50, allowing a security agent according to a company security policy to be installed, and switching a state of the terminal 20 to a first terminal according to a result of the installation. In other words, the security environment inspection unit 12 may be understood as a configuration that performs all the functions mentioned in the steps S20, S21, S22, and S23 described above.

The access permission unit 13 may perform a function of managing access of the terminal 20 to the remote server 40 according to a security environment checking result of the security environment inspection unit 12. In other words, the access permission unit 13 may be understood as a configuration that performs all the functions mentioned in the step S30 described above.

Although such a network environment is shown in FIG. 3, a more realistically schematized result is shown in FIG. 6. Referring to FIG. 6, in a home network environment A of a telecommuting environment, a remote PC, that is, the terminal 20, may attempt to access the remote server 40 via the apparatus 10 according to the present invention, for example, a gateway in which the apparatus according to the present invention is installed through remote access. The access attempt may begin with transmission of the request signal described above. In this case, the host sensor 30 may check the security environment of the terminal 20 by decoding and analyzing a packet of the request signal according to execution of the function described above, in which when the security environment is appropriate, the access to the server 40 in a company internal network environment B may be permitted, and otherwise, access to the security server 50 corresponding to a company work DMZ zone may be induced through a web 51 so as to install the security agent.

FIG. 7 shows one example of an internal configuration of a computing device according to one embodiment of the present invention. In the following description, redundant descriptions of the embodiment corresponding to the above descriptions for FIGS. 1 to 6 will be omitted.

As shown in FIG. 7, a computing device 10000 may at least include at least one processor 11100, a memory 11200, a peripheral interface 11300, an input/output (I/O) subsystem 11400, a power circuit 11500, and a communication circuit 11600. In this case, the computing device 10000 may correspond to a user terminal A connected to a tactile interface device, or correspond to a computing device B described above.

The memory 11200 may include, for example, a high-speed random access memory, a magnetic disk, an SRAM, a DRAM, a ROM, a flash memory, or a non-volatile memory. The memory 11200 may include a software module, an instruction set, or other various data required for an operation of the computing device 10000.

In this case, access to the memory 11200 from other components such as the processor 11100 or the peripheral interface 11300 may be controlled by the processor 11100.

The peripheral interface 11300 may couple an input and/or output peripheral device of the computing device 10000 to the processor 11100 and the memory 11200. The processor 11100 may execute the software module or the instruction set stored in the memory 11200 to perform various functions for the computing device 10000 and process data.

The I/O subsystem 11400 may couple various input/output peripheral devices to the peripheral interface 11300. For example, the I/O subsystem 11400 may include a controller for coupling the peripheral device, such as a monitor, a keyboard, a mouse, a printer, or a touch screen or a sensor if necessary, to the peripheral interface 11300. According to another aspect, input/output peripheral devices may be coupled to the peripheral interface 11300 without passing through the I/O subsystem 11400.

The power circuit 11500 may supply a power to all or some of the components of the terminal. For example, the power circuit 11500 may include a power management system, at least one power source such as a battery or an alternating current (AC), a charging system, a power failure detection circuit, a power switcher or inverter, a power status indicator, or any other components for generating, managing, or distributing a power.

The communication circuit 11600 may use at least one external port to enable communication with other computing devices.

Alternatively, as described above, the communication circuit 11600 may include an RF circuit, if necessary, to transmit and receive an RF signal, also known as an electromagnetic signal, thereby enabling the communication with other computing devices.

The above embodiment of FIG. 7 is merely one example of the computing device 10000, and the computing device 10000 may have a configuration or arrangement that omits some of the components shown in FIG. 7, further includes an additional component that is not shown in FIG. 7, or combines at least two components. For example, a computing device for a communication terminal in a mobile environment may further include a touch screen, a sensor, and the like in addition to the components shown in FIG. 7, and the communication circuit 11600 may include a circuit for RF communication in various communication schemes (Wi-Fi, 3G, LTE, Bluetooth, NFC, Zigbee, etc.). The components that may be included in the computing device 10000 may be implemented as hardware, software, or a combination of both hardware and software including at least one integrated circuit specialized in signal processing or an application. The methods according to the embodiment of the present invention may be implemented in the form of program instructions that may be executed through various computing devices, and may be recorded in a computer-readable medium. In particular, a program according to the present embodiment may be configured as a PC-based program or an application dedicated to a mobile terminal. An application to which the present invention is applied may be installed in a user terminal through a file provided by a file distribution system. For example, the file distribution system may include a file transmission unit (not shown) for transmitting the file according to a request from the user terminal.

The device described above may be implemented as a hardware component, a software component, and/or a combination of the hardware component and the software component. For example, the devices and components described in the embodiments may be implemented by using at least one general-purpose or special-purpose computer such as a processor, a controller, an arithmetic logic unit (ALU), a digital signal processor, a microcomputer, a field programmable gate array (FPGA), a programmable logic unit (PLU), a microprocessor, or any other device capable of executing and responding to an instruction. A processing device may execute an operating system (OS) and at least one software application executed on the operating system. In addition, the processing device may access, store, manipulate, process, and generate data in response to the execution of the software. In some cases, one processing device has been described as being used for convenience of understanding. However, it will be appreciated by those skilled in the art that the processing device may include a plurality of processing elements and/or a plurality of types of processing elements. For example, the processing device may include a plurality of processors or one processor, and one controller. In addition, other processing configurations such as a parallel processor may also be possible.

The software may include a computer program, a code, an instruction, or a combination of at least one thereof, and may configure the processing device to operate as desired or instruct the processing device independently or collectively. In order for the software and/or data to be interpreted by the processing device or to provide an instruction or data to the processing device, the software and/or data may be permanently or temporarily embodied in any type of machine, component, physical device, virtual equipment, computer storage medium, or device. The software may be distributed over computing devices, which are connected through a network, so as to be stored or executed in a distributed manner. The software and data may be stored in at least one computer-readable recording medium.

The method according to the embodiment may be implemented in the form of a program instruction that may be executed through various computer mechanisms, and may be recorded in a computer-readable medium. The computer-readable medium may include a program instruction, a data file, a data structure, and the like, alone or in combination with each other. The program instruction recorded in the medium may be specially designed and configured for the embodiment, or may be publicly known and available to those skilled in the art of computer software. An example of the computer-readable recording medium includes magnetic media such as a hard disk, a floppy disk, and a magnetic tape, optical media such as a CD-ROM and a DVD, magneto-optical media such as a floptical disk, and a hardware device specially configured to store and execute a program instruction, such as a ROM, a RAM, and a flash memory. An example of the program instruction includes a high-level language code that may be executed by a computer by using an interpreter or the like, as well as a machine language code generated by a compiler. The hardware device may be configured to operate as at least one software module to perform the operations of the embodiments, and vice versa.

Although the above description has been made with reference to specific embodiments and drawings, various modifications and changes can be made by those skilled in the art from the above description. For example, even when the described techniques are performed in an order that is different from the described manner, and/or the described components such as systems, structures, devices, and circuits are coupled or combined in a form that is different from the described manner, or replaced or substituted by other components or equivalents, appropriate results may be achieved. Therefore, other implementations, other embodiments, and equivalents to the claims are also within the scope of the appended claims.

What is claimed is:

1. A method for controlling access to a remote system in a home network environment, which is implemented by a computing device including at least one processor and at least one memory for storing instructions executable by the processor, the method comprising:
an access request reception step of receiving a request signal according to a network protocol when an access request for a remote server, which is an access target, is performed by a terminal on a home network;
a security environment inspection step of checking a security environment of the terminal through a host sensor for checking the security environment of the terminal by catching and analyzing the request signal, which is a sensor for each protocol that has received the request signal through the access request reception step, and which is a sensor connected to a gateway of the home network environment; and
an access permission step of managing access to the remote server according to the security environment checked according to a result of performing the security environment inspection step,
wherein the security environment inspection step includes:
a packet transmission step of transmitting a packet included in the request signal of the terminal to the host sensor;
an inspection step of receiving inspection information, which is information on whether the terminal is a first terminal that is in a managed state or a second terminal that is in an unmanaged state, from the host sensor as a result derived by analyzing the packet by the host sensor; and
a terminal processing step of performing processing for switching the terminal to the first terminal that is in the managed state when the terminal is the second terminal as a determination result of the inspection step,
wherein the inspection information refers to information on the security environment derived from information on the packet as a result of decoding the packet for each protocol and organizing detailed information on the packet by the host sensor, in which the information on the security environment is determination information on whether values in a detailed column and a format of the packet are set in the packet by a function of a security agent as a result of decoding the packet included in the request signal, and the inspection information is a result of determining whether the security agent to be installed in the terminal is installed according to a security policy set in the remote server, and determining a terminal in which all security agents are installed as the first terminal and a terminal in which the security agent is not installed as the second terminal, and
wherein the terminal processing step includes redirecting a packet of the second terminal to a security server for performing an installation process of the security agent according to the security policy set in the remote server, which is a server provided separately from the remote server, and which is a security server in a company internal network environment provided separately from an internal server of the company internal network environment, so as to control the terminal to access an installation page of the security agent.

2. The method of claim 1, wherein the terminal processing step includes switching the second terminal to the first terminal when determined that the second terminal has accessed the security server to install all the security agents.

3. The method of claim 1, wherein the access permission step includes permitting the access to the remote server only when the terminal is the first terminal.

4. An apparatus for controlling access to a remote system in a home network environment, which is implemented by a computing device including at least one processor and at least one memory for storing instructions executable by the processor, the apparatus comprising:
an access request reception unit for receiving a request signal according to a network protocol when an access request for a remote server, which is an access target, is performed by a terminal on a home network;
a security environment inspection unit for checking a security environment of the terminal by verifying the request signal received by the access request reception unit through a host sensor for each protocol; and
an access permission unit for managing access to the remote server according to a security environment checking result of the security environment inspection unit,
wherein the security environment inspection unit transmits a packet included in the request signal of the terminal to the host sensor, receives inspection information, which is information on whether the terminal is a first terminal that is in a managed state or a second terminal that is in an unmanaged state, from the host sensor as a result derived by analyzing the packet by the host sensor, and performs processing for switching the terminal to the first terminal that is in the managed state when the terminal is the second terminal,
wherein the inspection information refers to information on the security environment derived from information on the packet as a result of decoding the packet for each protocol and organizing detailed information on the packet by the host sensor, in which the information on the security environment is determination information on whether values in a detailed column and a format of the packet are set in the packet by a function of a security agent as a result of decoding the packet included in the request signal, and the inspection information is a result of determining whether the security agent to be installed in the terminal is installed according to a security policy set in the remote server, and determining a terminal in which all security agents are installed as the first terminal and a terminal in which the security agent is not installed as the second terminal, and
wherein, while the security environment inspection unit performs processing for switching the terminal to the first terminal that is in the managed state when the terminal is the second terminal, the security environment inspection unit redirects a packet of the second terminal to a security server for performing an installation process of the security agent according to the security policy set in the remote server, which is a server provided separately from the remote server, and which is a security server in a company internal network environment provided separately from an internal server of the company internal network environment, so as to control the terminal to access an installation page of the security agent.

5. A computer-readable recording medium, wherein the computer-readable recording medium stores instructions for allowing a computing device to perform:
an access request reception step of receiving a request signal according to a network protocol when an access request for a remote server, which is an access target, is pertained by a terminal on a home network;
a security environment inspection step of checking a security environment of the terminal through a host sensor for each protocol that has received the request signal through the access request reception step; and
an access permission step of managing access to the remote server according to a result of performing the security environment inspection step,
wherein the security environment inspection step includes:
a packet transmission step of transmitting a packet included in the request signal of the terminal to the host sensor;
an inspection step of receiving inspection information, which is information on whether the terminal is a first terminal that is in a managed state or a second terminal that is in an unmanaged state, from the host sensor as a result derived by analyzing the packet by the host sensor; and
a terminal processing step of performing processing for switching the terminal to the first terminal that is in the managed state when the terminal is the second terminal as a determination result of the inspection step,
wherein the inspection information refers to information on the security environment derived from information on the packet as a result of decoding the packet for each protocol and organizing detailed information on the packet by the host sensor, in which the information on the security environment is determination information on whether values in a detailed column and a format of the packet are set in the packet by a function of a security agent as a result of decoding the packet included in the request signal, and the inspection information is a result of determining whether the security agent to be installed in the terminal is installed according to a security policy set in the remote server, and determining a terminal in which all security agents are installed as the first terminal and a terminal in which the security agent is not installed as the second terminal, and
wherein the terminal processing step includes redirecting a packet of the second terminal to a security server for performing an installation process of the security agent according to the security policy set in the remote server, which is a server provided separately from the remote server, and which is a security server in a company internal network environment provided separately from an internal server of the company internal network environment, so as to control the terminal to access an installation page of the security agent.
